(19) United States
(12) Patent Application Publication
(10) Pub. No.: US 2020/0159339 A1
(43) Pub. Date: May 21, 2020

(54) Desktop spatial stereoscopic interaction system

(71) Applicant: SHENZHEN FUTURE 3D EDU TECH CO.,LTD, Shenzhen, Guangdong (CN)

(72) Inventors: Peter RUAN, Shenzhen, Guangdong (CN); Tony ZHENG, Shenzhen, Guangdong (CN); Zhongqiu LIN, Shenzhen, Guangdong (CN)

(21) Appl. No.: 16/610,908

(22) PCT Filed: Jul. 31, 2017
(86) PCT No.: PCT/CN2017/095272

§ 371 Date: Nov. 4, 2019

(30) Foreign Application Priority Data
May 9, 2017 (CN) 2017205119779

(51) Int. Cl. G06F 3/0346; G06F 3/01; G06F 3/03

(52) U.S. Cl. CPC G06F 3/0346; G06F 3/0304; G06F 3/013

(57) ABSTRACT

A desktop spatial stereoscopic interaction system includes: a stereoscopic interaction device for tracking a visual observation point of the operator through an infrared coordinate component, so as to obtain an operation instruction for an interactive control device, as well as display a virtual stereoscopic content corresponding to the visual observation point; the infrared coordinate component for acquiring first and second spatial coordinate data and transmitting the first and second spatial coordinate data to the stereoscopic interaction device; a visual aid device for acquiring the virtual stereoscopic content from the stereoscopic interaction device; and the interactive control device for outputting the operation instruction to the stereoscopic interaction device. The desktop spatial stereoscopic interaction system greatly improves accuracy of the interactive control device, eliminates the signal drift during operation of the interactive control device and reduces a processing load of the stereoscopic interaction device.

### CROSS REFERENCE OF RELATED APPLICATION

This is a U.S. National Stage under 35 U.S.C 371 of the International Application PCT/CN2017/095272, filed Jul. 31, 2017, which claims priority under 35 U.S.C. 119(a-d) to CN 2017205119779, filed May. 9, 2017.

### BACKGROUND OF THE PRESENT INVENTION

### Field of Invention

The present invention relates to a technical field of multi-space stereoscopic interaction, and more particularly to a desktop spatial stereoscopic interaction system capable of quickly processing spatial data of a control device.

### Description of Related Arts

When a 2D video is displayed, the video image frames are displayed continuously regardless of the left and right eye angles, and the interval between the image frames is short. Therefore, the human eye sees a video of continuous scenes. However, the acquisition process of the stereoscopic images or videos is far more complicated, wherein two cameras are required side by side for shooting. The dedicated stereoscopic camera consists of two imaging lenses, which are equivalent to two eyes of a person, so that two sets of images with parallax are obtained. The two sets of images are processed by special equipment or software, so as to be synthesized into a set of images. Conventionally, the standard synthesis adopts a left and right format, that is, the left eye image is compressed by ½ and placed on the left side of the screen, and the right eye image is compressed by ½ and placed on the right side of the screen. With a dedicated stereoscopic device, the left and right eye images are moved to the middle of the screen and doubled in width to restore the original image ratio. Without visual aids such as polarized glasses or shutter-type active glasses, the human eyes will get a double vision on the screen because each shot will have two different angles of views which will be superimposed on the screen. In order to obtain a better stereoscopic effect in practice, not only the visual aid device is required, but also the head spatial coordinate information of the viewer should be obtained to determine the visual observation point information. If the stereoscopic image is to be manipulated, a control device is required. For gripping, dragging, moving and zooming the stereoscopic image in a space, spatial position information of the control device should be precisely tracked.

### Technical Problems are as Follows.

In the conventional interaction system, the spatial position of the interactive control device is determined by the infrared positioning unit, so as to interact with the stereoscopic interaction device. However, due to the complicated operation of the interactive control device, the signal drift thereof may occur during the actual interaction process. As a result, the user cannot accurately select the stereoscopic content during the interaction process, and the user experience is poor.

### SUMMARY OF THE PRESENT INVENTION

The operation of the interactive control device in the conventional spatial stereoscopic interaction system is complicated. In the actual interaction process, the problem of signal drift of the interactive control device may occur, and the user may not accurately select the stereoscopic content during the interaction process, and the user experience is poor. Therefore, an object of the present invention is to provide a desktop spatial stereoscopic interaction system, wherein a nine-axis motion sensor is set in an interactive control device for detecting raw data of three-dimensional acceleration, angular velocity and geomagnetic direction along X, Y, Z axis directions during operation, thereby greatly improving accuracy of the interactive control device, and eliminating the signal drift during operation of the interactive control device. An MCU is set in the interactive control device for processing raw data of the acceleration, angular velocity and geomagnetic direction to obtain Euler angle parameters and quaternion of the interactive control device. The stereoscopic interaction device only needs to fuse the Euler angle parameters and the quaternion with spatial coordinate data to obtain a precise attitude position, thereby reducing a processing load of the stereoscopic interaction device.

Accordingly, in order to accomplish the above objects, the present invention provides a desktop spatial stereoscopic interaction system for interaction between an operator and a stereoscopic interaction device, comprising:

a stereoscopic interaction device for tracking a visual observation point of the operator through an infrared coordinate component, so as to obtain an operation instruction for an interactive control device, as well as display a virtual stereoscopic content corresponding to the visual observation point;

the infrared coordinate component for acquiring first and second spatial coordinate data and transmitting the first and second spatial coordinate data to the stereoscopic interaction device;

a visual aid device for acquiring the virtual stereoscopic content from the stereoscopic interaction device; and

the interactive control device for outputting the operation instruction to the stereoscopic interaction device;

wherein the visual observation point is a spatial coordinate point of the visual aid device with respect to the virtual stereoscopic content; the interactive control device comprises a nine-axis motion sensor for detecting spatial attitude raw data, and an MCU (Micro Controller Unit) for processing the spatial attitude raw data into Euler angle parameters and a quaternion; wherein the nine-axis motion sensor is connected to the MCU.

According to a first aspect, a first possible implementation is that the infrared coordinate component comprises an infrared emitting unit, an optical capturing unit, a first optical identification point disposed on the visual aid device, and a second optical identification point disposed on the interactive control device.

According to the first possible implementation of the first aspect, a second possible implementation is that the infrared emitting unit comprises at least one infrared emitting device for emitting infrared light; the optical capturing unit comprises at least two infrared capturing cameras for acquiring target images; wherein the infrared emitting device and the infrared capturing cameras are embedded in the stereoscopic interaction device.

According to the first aspect, a third possible implementation is that the nine-axis motion sensor comprises an acceleration sensor unit, a gyroscope unit, and a geomagnetic sensor unit.

According to the first aspect, a fourth possible implementation is that the first optical identification point and the second optical identification point are active infrared emitting devices or passive optical reflection points.

According to the fourth possible implementation of the first aspect, a fifth possible implementation is that the first optical identification point is a passive optical reflection point, and a quantity of the passive optical reflection point is at least two; the second optical identification point is an active infrared emitting device which is disposed on a top of the interactive control device.

According to the first aspect, a sixth possible implementation is that the interactive control device is provided with programmable function buttons for operating the virtual stereoscopic content displayed by the stereoscopic interactive device.

According to the first aspect, a seventh possible implementation is that the visual aid device is polarized stereoscopic glasses or shutter-type stereoscopic glasses.

According to the first aspect, an eighth possible implementation is that lenses of the infrared capturing cameras have a viewing angle of at least 70 degrees.

According to the first aspect, a ninth possible implementation is that the infrared coordinate component of the stereoscopic interaction device has a capturing distance of 0-3m.

Beneficial Effects of the Present are as Follows.

The present provides a desktop spatial stereoscopic interaction system, wherein a nine-axis motion sensor is set in an interactive control device for detecting raw data of three-dimensional acceleration, angular velocity and geomagnetic direction along X, Y, Z axis directions during operation, thereby greatly improving accuracy of the interactive control device, and eliminating the signal drift during operation of the interactive control device. An MCU is set in the interactive control device for processing raw data of the acceleration, angular velocity and geomagnetic direction to obtain Euler angle parameters and quaternion of the interactive control device. The stereoscopic interaction device only needs to fuse the Euler angle parameters and the quaternion with spatial coordinate data to obtain a precise attitude position, thereby reducing a processing load of the stereoscopic interaction device.

### BRIEF DESCRIPTION OF THE DRAWINGS

In order to more clearly illustrate the technical solutions in the embodiments of the present invention, the drawings used in the description of the embodiments will be briefly described below. It is obvious that the drawings in the following description are only some implementations of the present invention, and other drawings may be obtained by those of ordinary skill in the art without inventive work.

FIG. 1 is a schematic diagram of logical connection of a desktop spatial stereoscopic interaction system;

FIG. 2 is a schematic diagram of logical composition of an interactive control device in the desktop spatial stereoscopic interaction system according to the present invention;

FIG. 3 illustrates logical composition and signal flow of an interactive control device in the desktop spatial stereoscopic interaction system according to the present invention;

FIG. 4 is a schematic diagram of a state self-test circuit of a visual aid device in the desktop spatial stereoscopic interaction system according to the present invention.

Element references: 30-stereoscopic interaction device, 31-infrared coordinate component, 32-interactive control device, 33-visual aid device, 311-infrared emitting unit, 312-infrared capturing unit, 313-first optical identification unit, 314-second optical identification unit, 321-MCU, 322-nine-axis motion sensor, 3221-acceleration sensor unit, 3222-gyroscope unit, 3223-geomagnetic sensor unit, 331-state self-test circuit, 3311-acceleration sensor detection circuit, 3312-angular velocity detection circuit, 3313-distance sensor detection circuit.

### DETAILED DESCRIPTION OF THE PREFERRED EMBODIMENT

The technical solutions in the present invention will be clearly and completely described in conjunction with the accompanying drawings. It is obvious that the described are only a part of the embodiments of the present invention, and not all of the embodiments. Based on the embodiments of the present invention, other embodiments obtained by those of ordinary skill in the art without inventive work are within the scope of protection of the present invention.

1. System of the Present Invention

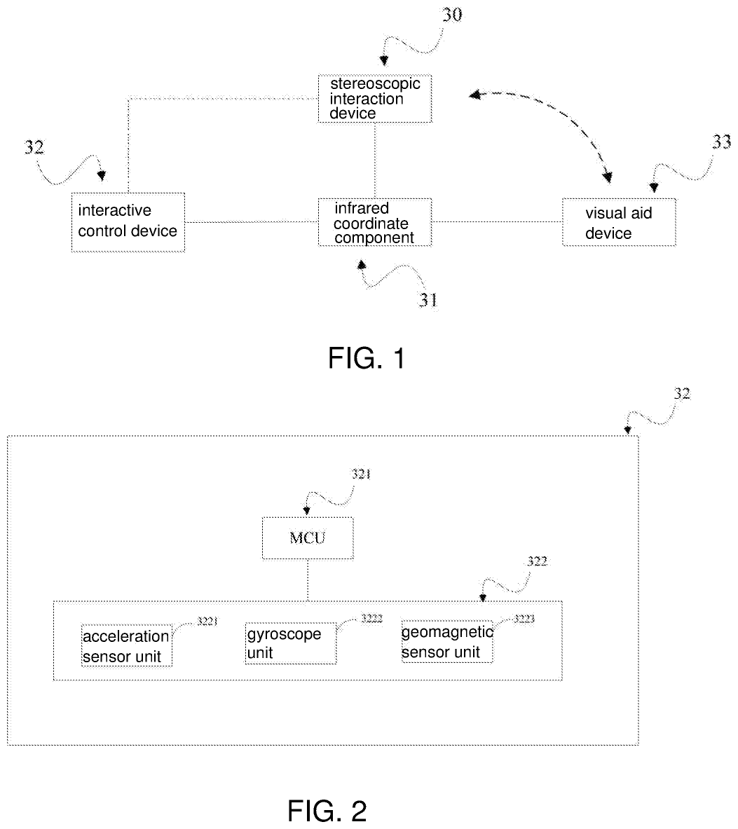

Referring to FIG. 1 which is a schematic diagram of logical connection of a desktop spatial stereoscopic interaction system, a desktop spatial stereoscopic interaction system is provided to precisely tracking an interactive control device 32, so as to solve the problem of signal drift of the prior art. The desktop spatial stereoscopic interaction system comprises a stereoscopic interaction device 30, an infrared coordinate component 31, the interactive control device 32 and a visual aid device 33, wherein the infrared coordinate component 31 tracks the visual aid device 33 and the interactive control device 32, and transmits spatial coordinate data to the stereoscopic interaction device 30. The spatial coordinate data of the visual aid device 33 is consistent with the visual observation point of the operator, wherein the visual observation point refers to the spatial positional relationship of the human eye to the display screen of the stereoscopic interaction device 30. The purpose of the stereoscopic interaction device 30 for determining the visual observation point is to display the corresponding stereoscopic image frames, so as to provide an optimal stereoscopic effect and realize interaction between the visual observation point of the operator and the stereoscopic interaction device 30. The interactive control device 32 is provided with a plurality of programmable function buttons for completing main interaction tasks between the operator and the stereoscopic interaction device 30. Due to the complicated operation of the interaction control device 32, the precise spatial attitude needs to be determined. The interactive control device 32 in the spatial stereoscopic interaction system adopts a nine-axis motion sensor 322 to detect spatial attitude change without dead angle, and pre-processes the detected spatial attitude raw data, so as to obtain and transmit Euler angle parameters and quaternion to the stereoscopic interaction device 30. The precise spatial attitude position of the interactive control device 32 can be obtained by just fusing the spatial coordinate data with the Euler angle parameters and the quaternion according to a spatial data fusion algorithm, thereby greatly reducing the processing load of the stereoscopic interaction device 30. The operator can operate the stereoscopic object in the virtual scene of the stereoscopic interaction device 30 through the programmable function buttons as needed to realize human-computer interaction.

2. System Embodiment

A desktop spatial stereoscopic interaction system for interaction between an operator and a stereoscopic interaction device is provided, comprising:

a stereoscopic interaction device 30 for tracking a visual observation point of the operator through an infrared coordinate component 31, so as to obtain an operation instruction for an interactive control device 32, as well as display a virtual stereoscopic content corresponding to the visual observation point.

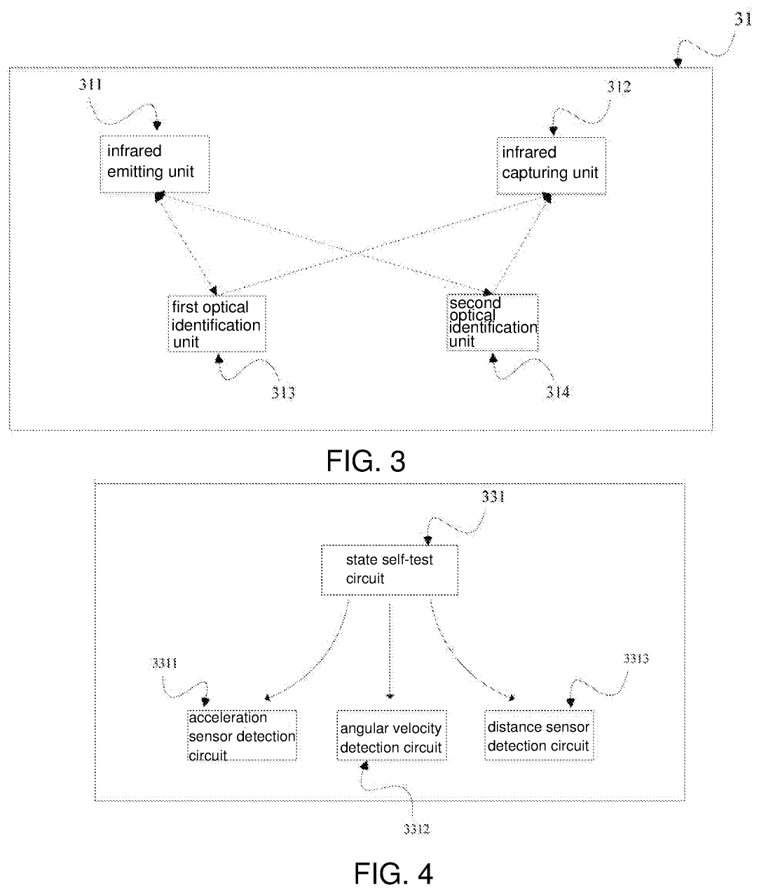

Referring to FIG. 3, logical composition and signal flow of an interactive control device in the desktop spatial stereoscopic interaction system according to the present invention are illustrated.

Preferably, the infrared coordinate component is provided for acquiring first and second spatial coordinate data and transmitting the first and second spatial coordinate data to the stereoscopic interaction device 30; the first and second spatial coordinate data are respectively spatial coordinate data of a visual aid device 33 and the interactive control device 32.

Preferably, the infrared coordinate component 31 comprises an infrared emitting unit 311, an optical capturing unit 312, a first optical identification point 313 disposed on the visual aid device 33, and a second optical identification point 314 disposed on the interactive control device 32. The infrared emitting unit 311 comprises at least one infrared emitting device for emitting infrared light; the optical capturing unit 312 comprises at least two infrared capturing cameras for acquiring target images; wherein the infrared emitting device and the infrared capturing cameras are embedded in the stereoscopic interaction device 30.

Specifically, the stereoscopic interaction device 30 supports the shutter-type stereoscopic technology. After the stereoscopic image or video is input to the stereoscopic interaction device 30, the images with the refresh rate of at least 120 Hz of the stereoscopic interaction device 30 are alternately generated as left and right frames in the frame sequence format. The shutter-type glasses receive the synchronization signal of the stereoscopic interaction device 30, thereby opening or closing the left and right liquid crystal lenses at the same frequency for refreshing the synchronization to see the corresponding images by the left and right eyes. The frame rate is maintained the same as that of a 2D video. Two eyes of the operator see different images which are quickly switched, and create illusions in the brain to view stereoscopic images. The stereoscopic interaction device 30 in the embodiment has a built-in optical processing unit, which can also be used with polarized stereoscopic glasses, wherein the original image is divided into vertically polarized light and horizontally polarized light by changing the arrangement of the liquid crystal molecules of the liquid crystal display screen in the stereoscopic interaction device 30. Then, the polarized lenses of different polarization directions are respectively used on the right and left sides of the stereoscopic glasses, so that the left and right eyes can receive two sets of images to synthesize the stereoscopic images through the brain.

The infrared emitting unit 311 in the infrared coordinate component 31 comprises at least one infrared emitting device for emitting infrared light, wherein the infrared emitting device is configured to emit infrared light to optical reflecting points of the visual aid device 33 or the interactive operating device 32, and is embedded in the stereoscopic interaction device 30, so as to obtain images by the infrared capturing camera of the infrared coordinate component 31 and determine its spatial coordinates. Therefore, the angle and the number of the infrared emitting device have an influence on the image capturing effect of the infrared capturing camera. Preferably, the infrared emitting unit 311 adopts four infrared emitting devices, wherein two are disposed at left side of the stereoscopic interactive device 30 while the other two are disposed on right side of the stereoscopic interactive device 30 to ensure that the emitted infrared light can effectively cover the liquid crystal display screen of the entire stereoscopic device. The four infrared emitting devices can also be respectively embedded in the upper and lower sides or either side of the display screen. The four infrared emitting devices are used to emit infrared light. After being reflected by the optical identification points, the infrared capturing unit 312 acquires spatial images of the visual aid device 33 or the interactive control device 32 having the optical identification points. After acquiring the spatial images, the stereoscopic interaction device 30 obtains the spatial coordinates of the visual aid device 33 or the interactive control device 32 according to a spatial image coordinate algorithm. However, if the capturing distance of the infrared capturing camera is not highly restricted, only one infrared emitting device can also track the visual aid device 33 and the interactive control device 32 without restricting position and number of the infrared emitting device.

The optical capturing unit 312 comprises at least two infrared capturing cameras for acquiring target images, so as to effectively acquire spatial coordinate data of the target and simultaneously acquire spatial images having parallax characteristics of the spatial target. The spatial coordinates of the spatial target can be obtained according to the positions of the infrared capturing cameras and the projection principles. Preferably, the infrared capturing unit 312 has four infrared capturing cameras embedded in the stereoscopic interaction device, and the two adjacent cameras compensate each other. Alternatively, there can be two or more than four infrared capturing cameras. Increasing elevation angles of the infrared capturing camera can expand the capturing distance, but the acquired image will have larger distortion, and the error of the acquired target spatial coordinates is also larger. According to the embodiment, the elevation angles of the infrared capturing cameras are at least 70 degrees, preferably 70-130 degrees. Within the above range, the infrared capturing cameras can obtain almost undistorted spatial images within a capturing distance of 0-3 m, and can obtain relatively accurate target spatial coordinates when the capturing distance is large.

According to the embodiment, the infrared capturing cameras have a refresh rate of greater than 60 Hz, which can greatly improve the smoothness of the infrared capturing cameras when capturing target trajectory and improve tracking accuracy, thereby improving stereoscopic effects of the images acquired by the visual aid device 33.

Before installation, the infrared light emitted by the four infrared emitting devices is tested according to the size of the display screen to determine angles between the four infrared emitting devices and the four infrared capturing cameras and the display screen. Adjacent infrared emitting devices at the same side can compensate each other to fully cover the entire liquid crystal display screen. Similarly, adjacent infrared capturing cameras at the same side can compensate each other to effectively capture images of the visual aid device 33 or the interactive control device 32 in the infrared light emission range.

The first optical identification point 313 is disposed on the visual aid device 33, and the second optical identification point 314 is disposed on the interactive control device 32. The first and second optical identification points may be active infrared emitting devices, or passive optical reflection points. Preferably, the first optical identification point 313 is a passive optical reflection point, and the second optical identification point 314 is an active infrared emitting device. An infrared light reflecting substance is disposed on the passive optical reflection point. If the passive optical identification point is set on the polarized glasses, it won't increase cost as the infrared emitting device circuit of the active shutter-type glasses does.

The second optical identification point 314 is disposed on a circuit board inside the interactive control device 32, and the active infrared emitting device can avoid the hand-inconvenience and wear problem caused by the passive infrared reflection point. The number of infrared emitting devices according to the embodiment is preferably two: respectively disposed at two top positions of the internal circuit board of the interactive control device 32, so that even if one of the infrared emitting devices is blocked, the interactive control device 32 can be effectively tracked by the stereoscopic interaction device 30. It should be noted that there may be multiple infrared emitting devices, which is not limited here in the embodiment and can be determined according to actual needs.

The visual aid device 33 is worn on the head, which reflects the infrared light by the infrared reflection points, and captures images by the infrared capturing cameras, so as to determine the coordinates of the operator's head. There are at least two infrared reflection points arranged at any position of the visual aid device 33, preferably:

when there are three infrared reflection points, one of which is set at a nose pad position of the visual aid device 33, and the other two are symmetric with respect to the nose pad and respectively disposed at an up-left corner of the left lens and an up-right corner of the right lens, so that the head dynamic coordinates can be completely tracked;

when there are four infrared reflection points, one of which is set at a nose pad position of the visual aid device 33, and two of the remaining three are symmetric with respect to the nose pad and respectively disposed at an up-left corner of the left lens and an up-right corner of the right lens; the last one is set at a down-left corner of the left lens or a down-right corner of the right lens;

when there are fifth infrared reflection points, one of which is set at a nose pad position of the visual aid device 33, and the remaining 4 are respectively disposed at an up-left corner and a down-left corner of the left lens as well as an up-right corner and a down-right corner of the right lens; the five infrared reflection points define a frame of the polarized glasses, which ensures the accuracy of head tracking.

The number of infrared emitting points can be more without considering the cost factor.

The System Further Comprises:

the visual aid device 33 for acquiring the virtual stereoscopic content from the stereoscopic interaction device 30.

The visual aid device 33 can be polarized stereoscopic glasses having a specific number of the infrared reflection points. The stereoscopic interaction device 30 in the embodiment has a built-in optical processing unit, wherein the original image is divided into vertically polarized light and horizontally polarized light by changing the arrangement of the liquid crystal molecules of the liquid crystal display screen in the stereoscopic interaction device 30. Then, the polarized lenses of different polarization directions are respectively used on the right and left sides of the stereoscopic glasses, so that the left and right eyes can receive two sets of images to synthesize the stereoscopic images through the brain.

The visual aid device 33 can also be active shutter-type glasses with a specific number of the infrared reflection points. After the stereoscopic image or video is input to the stereoscopic interaction device 30, the images with the refresh rate of at least 120 Hz of the stereoscopic interaction device 30 are alternately generated as left and right frames in the frame sequence format. The shutter-type glasses receive the synchronization signal of the stereoscopic interaction device 30, thereby opening or closing the left and right liquid crystal lenses at the same frequency for refreshing the synchronization to see the corresponding images by the left and right eyes. The frame rate is maintained the same as that of a 2D video. Two eyes of the operator see different images which are quickly switched, and create illusions in the brain to view stereoscopic images.

Referring to FIG. 4, a schematic diagram of a state self-test circuit of a visual aid device in the desktop spatial stereoscopic interaction system according to the present invention is provided.

The shutter-type glasses according to the embodiment have a state self-test function, so that the power can be turned off in time and the power consumption can be reduced. Specifically, a state self-test circuit 331 can be an acceleration sensor detection circuit 3311 to detect the state of the active shutter-type glasses. The acceleration sensor detection circuit 3311 can be two-axis or three-axis, wherein when the state changes or the distance parameter is detected to be less than a certain threshold, a working mode of a Bluetooth master chip is controlled within a certain time. For example, when it is detected that the state of the active shutter-type glasses is changed from stationary to motion, a time of waking up the Bluetooth main control chip is 2s. After 2s, the Bluetooth master chip of the active shutter-type glasses enters a working state, and the user starts to use. When it is detected that the state of the active shutter-type glasses is changed from motion to stationary, a set time is 3s. After 3s, the Bluetooth master chip of the active shutter-type glasses is stopped, and the user stops to use. By detecting the state of the active shutter-type glasses, the working modes of the Bluetooth master chip is automatically controlled, so as to save power, prolong effective endurance and improve user experience.

In order to realize automatic control of the power source, reduce waste of electric energy, and improve effective endurance, the state self-test circuit may also be an angular velocity detection circuit 3312 for detecting moving angle change of the active shutter-type glasses. The working mode of the Bluetooth master chip can be controlled by detecting the moving angle change of the glasses, which will not be further described here.

The state self-test circuit may also be the angular velocity detection circuit 3312 together with a distance sensor detection circuit 3313 to detect a distance from the active shutter-type glasses to the user's face. When the distance to the face is detected to be less than a threshold, the Bluetooth master chip of the active shutter-type glasses is switched. For example, when the distance between the active shutter-type glasses and the user's face has been less than 20 mm for more than 2s, the Bluetooth master chip of the active shutter-type glasses enters the working state; when the distance from the active shutter-type glasses to the user's face has been greater than 40 mm for more than 3s, the Bluetooth master chip of the active shutter-type glasses enters a sleep state.

Of course, the active shutter-type glasses can combine the acceleration sensor detection circuit 3311, the angular velocity detection circuit 3312, and the distance sensor detection circuit 3313 together to realize automatic control of the working mode of the Bluetooth master chip of the active shutter-type glasses, thereby improving the effective endurance and user experience. Therefore, any acceleration sensor detection circuit 3311, angular velocity detection circuit 3312, and distance sensor detection circuit 3313 used to detect motion state or distance parameter of the active shutter-type glasses, or any combination of the three, to automatically control the working mode of the Bluetooth master chip, are within the protection scope of the present invention.

In order to reduce the power consumption of the circuit board, as a preferred embodiment, the active shutter-type Bluetooth main control chip adopts a BCM series chip. The BCM series chip is a kind of Bluetooth main control chips produced by Broadcom Corporation, America. The chip has enhanced data transmission capability, support for Bluetooth communication technology and low power consumption, which is beneficial to increase the effective endurance of the active shutter-type glasses.

Referring to FIG. 2, a schematic diagram of logical composition of an interactive control device in the desktop spatial stereoscopic interaction system according to the present invention is provided.

The System of the Embodiment Further Comprises:

the interactive control device 32 for outputting the operation instruction to the stereoscopic interaction device 30.

Preferably, the interactive control device 32 comprises a nine-axis motion sensor 322 for detecting spatial attitude raw data, and an MCU (Micro Controller Unit) 321 for processing the spatial attitude raw data into Euler angle parameters and a quaternion; wherein the nine-axis motion sensor 322 is connected to the MCU 321.

The MCU 321 of the interactive control device 32 has strong processing capability, small size, and low cost, and is very suitable for the interactive control device 32 of the embodiment. If the volume requirement is not highly restricted, the processing unit can also adopt data processing chip such as DSP and FPGA.

Preferably, the motion sensor adopted is a nine-axis motion sensor 322. The stereoscopic interaction device 30 captures images through the infrared capturing cameras, which can only determine the spatial coordinate position of the interactive control device 32, and cannot track complete motion attitudes of the interactive control device 32 relative to display screen of the stereoscopic interaction device 30. The nine-axis motion sensor 322 is a combination of three types of sensors: a three-axis acceleration sensor unit 3221, a three-axis gyroscope unit 3222, and a three-axis geomagnetic sensor unit 3223, and the three portions cooperate with each other. With the acceleration sensor unit 3221 and gyroscope unit 3222, the complete motion states of the device can be basically described. However, with the long-distance movement, cumulative deviation will also occur, and the motion attitudes cannot be accurately described, such as the tilt of control screen. The geomagnetic sensor unit 3223 can correct the cumulative deviation by measuring the earth's magnetic field and correcting by an absolute pointing function, thereby correcting the moving direction, the attitude angle, the moving force and the speed of the interactive control device 32. Using the nine-axis motion sensor 322 can improve the accuracy of the dynamic attitude position tracking of the interactive control device 32, and avoid “drift” problem of the cursor of the interactive control device 32 on the stereoscopic interaction device 30.

Preferably, the attitude raw data detected by the nine-axis motion sensor 322 comprises acceleration, angular velocity, and direction in three degrees of freedom, wherein the nine-axis motion sensor 322 comprises the acceleration sensor unit 3221, the gyroscope unit 3222, and the geomagnetic sensor unit 3223. The absolute direction of the output of the nine-axis motion sensor 322 is derived from the gravity field of the earth and the magnetic field of the earth. The static final accuracy of the nine-axis motion sensor 322 depends on the measurement accuracy of the magnetic field and the gravity, while the dynamic performance depends on the gyroscope unit 3222. The acceleration sensor unit 3221 and the gyroscope unit 3222 in a consumer-grade nine-axis motion sensor have large interference noise. Taking planar gyro as an example, the integration of the gyroscope unit of ADI will drift about 2 degrees for one minute. If there is no magnetic field and gravity field to correct the three-axis gyro, then the actual attitude and measurement output attitude of the object will be completely changed after 3 minutes. Therefore, the structure of the low-cost gyroscope unit 3222 and the acceleration sensor unit 3221 must be corrected by field vectors. The nine-axis motion sensor 322 in the embodiment utilizes the three-dimensional gyroscope unit 3222 to quickly track the three-dimensional attitudes of the interactive control device 32, wherein the gyroscope unit 3222 unit is used as the core, and the directions of the acceleration and the geomagnetic field is also measured as a reliable system reference. Specifically, the absolute angular rate, acceleration, and magnetic field strength in three directions of the carrier are measured, so as to obtain quaternion, attitude data and the like of the interactive control device 32. A real-time integrated algorithm is needed to provide accurate, reliable, and stable attitude output for the system.

The refresh rate of the nine-axis motion sensor 322 in the embodiment is greater than 60 Hz, which ensures the smoothness of the spatial attitude trajectory of the interactive control device 32 acquired by the stereoscopic interaction device 30, in such a manner that the operation cursor signal is more continuous, and operation instruction can be executed in time.

Preferably, a shell of the interactive control device 32 has a common pen shape, and the interactive control device 32 is provided with a plurality of function buttons for operating the virtual stereoscopic content displayed by the stereoscopic interaction device 30. The shape and size of the pen-shaped shell should be suitable for the user to hold it.

The interactive control device 32 is connected to the stereoscopic interaction device 30 through a USB data line with HID transmission protocol, and the pen-shaped shell is provided with a gap for use with the USB interface. Compared to the conventional HDMI data line, the USB data line is more versatile, and its data transmission is more reliable than that of the wireless connection.

The interactive control device 32 is further provided with a plurality of function buttons, which are equivalent to the functions of an ordinary mouse before entering the stereoscopic content display, so as to move on the display screen of the stereoscopic interaction device 30 to select the stereoscopic content resources to be displayed. For example, clicking can enter or display the stereoscopic content. After entering the stereoscopic content, the button unit can also pop up menu shortcut keys, as well as grab and drag the stereoscopic content to move in all directions.

The spatial attitude data processing process according to the embodiment is as follows: the infrared coordinate component 31 respectively obtains the spatial position image of the visual aid device 33 and the interactive control device 32 to be transmitted to the stereoscopic interaction device 30, and the stereoscopic interaction device 30 acquires first and second spatial coordinate data according to a spatial location algorithm; an inter-control device acquires the spatial attitude raw data through the nine-axis sensor and transmits them to the MCU 321 for processing, and the MCU 321 processes the raw data into the Euler angle parameters and quaternion of the spatial attitude of the interactive control device 32 according to a spatial data fusion algorithm, and transmit to the stereoscopic interactive device 30; the stereoscopic interaction device 30 determines the spatial position and attitude of the interactive control device 32 based on the second spatial coordinate data, the Euler angle parameters and the quaternion, wherein the first and second spatial coordinate data are spatial coordinate data of the visual aid device 33 and the interactive control device 32, respectively. Specific interaction is as follows: the operator moves the cursor of the interactive control device 32 to a specific position of the virtual stereoscopic content displayed by the stereoscopic interaction device 30, and the stereoscopic interaction device 30 acquires an operation instruction of the interactive control device 32; the stereoscopic interactive device 30 operates a specific virtual stereoscopic display function in accordance with the operation instruction; the stereoscopic interactive device 30 acquires visual observation points of the operator through the infrared coordinate component 31, and transmits the stereoscopic display content matching the visual observation points to the operator's eyes through the visual aid device 33.

A spatial data processing method of the desktop spatial stereoscopic interaction system as shown in FIG. 1 comprises steps as follows.

Step 101: acquiring first and second spatial position images, and obtaining first and second spatial coordinate data according to a spatial position algorithm;

wherein the first and second spatial position images are spatial position images of the visual aid device 33 and the interactive control device 32, respectively, and the first and second spatial coordinate data respectively refer to spatial coordinate data determined by the visual aid device 33 and the interactive control device 32 through the infrared coordinate component 31.

The infrared coordinate component 31 respectively acquires and transmits the spatial position image of the visual aid device 33 and the interactive control device 32 to the stereoscopic interaction device 30, and the stereoscopic interaction device 30 acquires the first and second spatial coordinate data according to the spatial position algorithm.

The infrared emitting unit 311 in the infrared coordinate component 31 is preferably formed by four infrared emitting devices, or two; the four infrared emitting devices emit infrared light; after the infrared light is reflected by optical identification points, the infrared capturing unit 312 acquires spatial images of the visual aid device 33 or the interactive control device 32 provided with the optical identification points. After obtaining the spatial images, the stereoscopic interaction device 30 acquires spatial coordinates of the visual aid device 33 or interactive control device 32 according to the spatial image coordinate algorithm. Preferably, the infrared capturing unit 312 is formed by four infrared capturing cameras.

Step 102: acquiring spatial attitude raw data of the interaction control device 32, and processing the spatial attitude raw data into spatial attitude Euler angle parameters and quaternion;

wherein the interactive control device 32 detects the motion attitude of the interactive control device 32 through the nine-axis motion sensor 322, so as to acquire the spatial attitude raw data and transmit them to the MCU 321 for processing; and the MCU 321 processes the raw data into the spatial attitude Euler angle parameters and quaternion of the interactive control device 32, and transmits them to the stereoscopic interaction device 30.

The stereoscopic interaction device 30 captures images through the infrared capturing cameras, which can only determine the spatial coordinate position of the interactive control device 32, and cannot track complete motion attitudes of the interactive control device 32 relative to display screen of the stereoscopic interaction device 30. The nine-axis motion sensor 322 is a combination of three types of sensors: a three-axis acceleration sensor unit 3221, a three-axis gyroscope unit 3222, and a three-axis geomagnetic sensor unit 3223, and the three portions cooperate with each other. With the acceleration sensor unit 3221 and gyroscope unit 3222, the complete motion states of the device can be basically described. However, with the long-distance movement, cumulative deviation will also occur, and the motion attitudes cannot be accurately described, such as the tilt of control screen. The geomagnetic sensor unit 3223 can correct the cumulative deviation by measuring the earth's magnetic field and correcting by a absolute pointing function, thereby correcting the moving direction, the attitude angle, the moving force and the speed of the interactive control device 32. Using the nine-axis motion sensor 322 can improve the accuracy of the dynamic attitude position tracking of the interactive control device 32, and avoid “drift” problem of the cursor of the interactive control device 32 on the stereoscopic interaction device 30.

Step 103: determine spatial position attitude of the interactive control device 32 according to the second spatial coordinate data, the Euler angle parameters, and the quaternion by using a spatial data fusion algorithm;

wherein the stereoscopic interaction device 30 determines the spatial position attitude of the interactive control device 32 based on the second spatial coordinate data, the Euler angle parameters and the quaternion.

The stereoscopic interaction device 30 needs to fuse the spatial coordinate data of the interactive control device 32 and the attitude raw data (the Euler angle parameters and the quaternion) to obtain the final attitude, and then generates a corresponding spatial operation cursor.

The interaction method of the desktop spatial stereoscopic interaction system further comprises steps as follows:

Step 201, determining visual observation points of the operator wearing the visual aid device 33, and acquiring a function key operation instruction of the interactive control device 32, wherein the visual observation points are spatial coordinate points of the visual aid device 33 relative to the virtual stereoscopic content.

Stereoscopicity of an image frame is a result of the synthesis of left and right image frames having parallax characteristics in the human brain, which is actually an illusion. Therefore, the visual observation point has a very important influence on the stereoscopic effect of the virtual stereoscopic content displayed by the stereoscopic interaction device 30. During operation, the visual observation points of the operator are changed unconsciously, or changed for some certain observation purposes. The infrared coordinate component 31 tracks motion spatial coordinates of the head of the operator, and then determines the visual observation points, in such a manner that the virtual stereoscopic content displayed by the stereoscopic interaction device 30 has a better stereoscopic effect, and the interaction between the operator and the stereoscopic interaction device 30 is realized.

Step 202: displaying a virtual stereoscopic content matching the visual observation points according to the operation instruction.

The interactive control device 32 is provided with three different types of programmable function buttons for operating the virtual stereoscopic content displayed by the stereoscopic interaction device 30. Before entering the virtual stereoscopic content, the interactive control device 32 is equivalent to the function of an ordinary mouse, so as to move on the display screen of the stereoscopic interaction device 30 to select the stereoscopic content resources to be displayed. For example, clicking can enter or display the stereoscopic content. After entering the stereoscopic content, the button unit can also pop up menu shortcut keys, as well as grab and drag the stereoscopic content to move in all directions.

The stereoscopic interactive device 30 operates a specific virtual stereoscopic display function in accordance with the operation instruction. Step 203: acquiring visual observation points of the operator by the stereoscopic interaction device 30 through the infrared coordinate component 31, and transmitting the stereoscopic display content matching the visual observation points to eyes of the operator through the visual aid device 33.

It should be noted that after determining the spatial attitude of the interactive control device 32, the spatial attitude data detected by the nine-axis motion sensor 322 corrects the spatial coordinate data detected by the infrared coordinate component 31, thereby effectively improving tracking accuracy of the spatial position of the interactive control device 32.

According to the embodiment, a desktop spatial stereoscopic interaction system is provided to precisely tracking an interactive control device 32, so as to solve the problem of signal drift of the prior art. The desktop spatial stereoscopic interaction system comprises a stereoscopic interaction device 30, an infrared coordinate component 31, the interactive control device 32 and a visual aid device 33, wherein the infrared coordinate component 31 tracks the visual aid device 33 and the interactive control device 32, and transmits spatial coordinate data to the stereoscopic interaction device 30. The spatial coordinate data of the visual aid device 33 is consistent with the visual observation point of the operator, wherein the visual observation point refers to the spatial positional relationship of the human eye to the display screen of the stereoscopic interaction device 30. The purpose of the stereoscopic interaction device 30 for determining the visual observation point is to display the corresponding stereoscopic image frames, so as to provide an optimal stereoscopic effect and realize interaction between the visual observation point of the operator and the stereoscopic interaction device 30. The interactive control device 32 is provided with a plurality of programmable function buttons for completing main interaction tasks between the operator and the stereoscopic interaction device 30. Due to the complicated operation of the interaction control device 32, the precise spatial attitude needs to be determined. The interactive control device 32 in the spatial stereoscopic interaction system adopts a nine-axis motion sensor 322 to detect spatial attitude change without dead angle, and pre-processes the detected spatial attitude raw data, so as to obtain and transmit Euler angle parameters and quaternion to the stereoscopic interaction device 30. The precise spatial attitude position of the interactive control device 32 can be obtained by just fusing the spatial coordinate data with the Euler angle parameters and the quaternion according to a spatial data fusion algorithm, thereby greatly reducing the processing load of the stereoscopic interaction device 30. The operator can operate the stereoscopic object in the virtual scene of the stereoscopic interaction device 30 through the programmable function buttons as needed to realize human-computer interaction.

The above are only the preferred embodiment of the present invention, and are not intended to be limiting. Any modifications, equivalents, improvements and the like under the spirit and principles of the present invention, should be regarded as within the scope of protection of the present invention.

1. A desktop spatial stereoscopic interaction system for interaction between an operator and a stereoscopic interaction device, comprising:
a stereoscopic interaction device for tracking a visual observation point of the operator through an infrared coordinate component, so as to obtain an operation instruction for an interactive control device, as well as display a virtual stereoscopic content corresponding to the visual observation point;
the infrared coordinate component for acquiring first and second spatial coordinate data and transmitting the first and second spatial coordinate data to the stereoscopic interaction device;
a visual aid device for acquiring the virtual stereoscopic content from the stereoscopic interaction device; and
the interactive control device for outputting the operation instruction to the stereoscopic interaction device;
wherein the visual observation point is a spatial coordinate point of the visual aid device with respect to the virtual stereoscopic content; the interactive control device comprises a nine-axis motion sensor for detecting spatial attitude raw data, and an MCU (Micro Controller Unit) for processing the spatial attitude raw data into Euler angle parameters and a quaternion; wherein the nine-axis motion sensor is connected to the MCU.

2. The desktop spatial stereoscopic interaction system, as recited in claim 1, wherein the infrared coordinate component comprises an infrared emitting unit, an optical capturing unit, a first optical identification point disposed on the visual aid device, and a second optical identification point disposed on the interactive control device.

3. The desktop spatial stereoscopic interaction system, as recited in claim 2, wherein the infrared emitting unit comprises at least one infrared emitting device for emitting infrared light; the optical capturing unit comprises at least two infrared capturing cameras for acquiring target images; wherein the infrared emitting device and the infrared capturing cameras are embedded in the stereoscopic interaction device.

4. The desktop spatial stereoscopic interaction system, as recited in claim 1, wherein the nine-axis motion sensor comprises an acceleration sensor unit, a gyroscope unit, and a geomagnetic sensor unit.

5. The desktop spatial stereoscopic interaction system, as recited in claim 2, wherein the first optical identification point and the second optical identification point are active infrared emitting devices or passive optical reflection points.

6-10. (canceled)

11. The desktop spatial stereoscopic interaction system, as recited in claim 2, wherein the first optical identification point is a passive optical reflection point, and a quantity of the passive optical reflection point is at least two; the second optical identification point is an active infrared emitting device which is disposed on a top of the interactive control device.

12. The desktop spatial stereoscopic interaction system, as recited in claim 5, wherein the first optical identification point is a passive optical reflection point, and a quantity of the passive optical reflection point is at least two; the second optical identification point is an active infrared emitting device which is disposed on a top of the interactive control device.

13. The desktop spatial stereoscopic interaction system, as recited in claim 1, wherein the interactive control device is provided with programmable function buttons for operating the virtual stereoscopic content displayed by the stereoscopic interactive device.

14. The desktop spatial stereoscopic interaction system, as recited in claim 1, wherein the visual aid device is polarized stereoscopic glasses or shutter-type stereoscopic glasses.

15. The desktop spatial stereoscopic interaction system, as recited in claim 3, wherein lenses of the infrared capturing cameras have a viewing angle of at least 70 degrees.

16. The desktop spatial stereoscopic interaction system, as recited in claim 1, wherein the infrared coordinate component of the stereoscopic interaction device has a capturing distance of 0-3 m.

17. A spatial data processing method of a desktop spatial stereoscopic interaction system, comprising steps of:
Step 101: acquiring first and second spatial position images, and obtaining first and second spatial coordinate data according to a spatial position algorithm;
Step 102: acquiring spatial attitude raw data of an interaction control device, and processing the spatial attitude raw data into spatial attitude Euler angle parameters and quaternion; and
Step 103: determine spatial position attitude of the interactive control device according to the second spatial coordinate data, the Euler angle parameters, and the quaternion by using a spatial data fusion algorithm;
wherein the interactive control device comprises a nine-axis motion sensor for detecting the spatial attitude raw data, and an MCU (Micro Controller Unit) for processing the spatial attitude raw data into the Euler angle parameters and the quaternion;
wherein the nine-axis motion sensor is connected to the MCU.

18. The spatial data processing method, as recited in claim 17, wherein an interaction method thereof comprises steps of:
Step 201, determining a visual observation point of an operator wearing a visual aid device, and acquiring an operation instruction of the interactive control device; and
Step 202: displaying a virtual stereoscopic content matching the visual observation point according to the operation instruction.
